(19) United States
(12) Patent Application Publication
(10) Pub. No.: US 2017/0332309 A1
(43) Pub. Date: Nov. 16, 2017

(54) SERVICE IDENTIFICATION METHOD, NETWORK ENTITY AND USER EQUIPMENT USING THE SAME

(71) Applicant: Industrial Technology Research Institute, Hsinchu (TW)

(72) Inventor: Ying-Yu Chen, Hsinchu County (TW)

(73) Assignee: Industrial Technology Research Institute, Hsinchu (TW)

(21) Appl. No.: 15/390,737

(22) Filed: Dec. 27, 2016

Related U.S. Application Data
(60) Provisional application No. 62/335,686, filed on May 13, 2016.
(60) Provisional application No. 62/358,156, filed on Jul. 5, 2016.

(30) Foreign Application Priority Data
Dec. 8, 2016 (TW) 105140581

(51) Int. Cl. H04W 48/10; H04L 29/08; H04W 48/16

(52) U.S. Cl. CPC H04W 48/10; H04W 48/16; H04L 67/12; H04L 67/16

(57) ABSTRACT

A service identification method, a network entity and a user equipment using the same are provided. In one of the exemplary embodiments, this method is adapted to the network entity and includes at least but not limited to: receiving a broadcast service identifier allocation request; allocating at least one broadcast service identifier of at least one broadcast service in response to reception of the broadcast service identifier allocation request, wherein each of the at least one broadcast service identifier includes both of a service identification information and an area identification information, the service identification information is configure to identify the at least one broadcast service, and the area identification information is used to identify a target area corresponding to a broadcast service content of the broadcast service; and transmitting the at least one broadcast service identifier including the service identification information and the area identification information.

### CROSS-REFERENCE TO RELATED APPLICATION

This application claims the priority benefits of U.S. provisional application Ser. No. 62/335,686, filed on May 13, 2016, U.S. provisional application Ser. No. 62/358,156, filed on Jul. 5, 2016, and Taiwan application serial no. 105140581, filed on Dec. 8, 2016. The entirety of each of the above-mentioned patent applications is hereby incorporated by reference herein and made a part of this specification.

### BACKGROUND OF THE DISCLOSURE

### Field of the Disclosure

The disclosure relates to a service identification method, and particularly relates to a service identification method combining services with geographic area information, and a network entity and a user equipment using the same.

### Description of Related Art

Vehicle to everything (V2X) is a vehicle data transmission technique based on a 3GPP communication protocol, and includes vehicle to vehicle (V2V) communication, vehicle to pedestrian (V2P) communication and vehicle to infrastructure (V2I) communication, etc., and such technique mainly uses a vehicle smart terminal equipment to implement vehicle data transmission.

In order to implement information exchange between a vehicle and the external, the vehicle has to notify related information (for example, location information of itself and warning information, etc.) to the other vehicles around, periodically or in a triggering manner. FIG. 1 is a schematic diagram illustrating a situation that the V2X information is broadcasted in different multimedia broadcast multicast services (MBMS) broadcast areas according to current locations of vehicle. As shown in FIG. 1, the V2X information is respectively broadcasted in the MBMS broadcast areas 111, 112, 113, 114 according to the current locations 101, 102, 103, 104 of the vehicles. Namely, if the MBMS service is adopted to implement the information exchange between the vehicle and the external, a situation of overlapped broadcast areas is probably occurred.

However, according to the current standards of the 3GPP communication protocol TS 23.246, one MBMS service only corresponds to one temporary mobile group identity (TMGI). Moreover, although the MBMS broadcast area is composed of one or a plurality of sub areas, the sub areas are not overlapped to each other. Namely, the V2X service who has to rely on a plurality of probably overlapped small areas to implement information transmission may conflict with the current standards. In other words, if different contents belonging to a same service are required to use a same TMGI, not only a flow identifier (FID) is additionally required for identification, the overlapped areas cannot be used for transmission. Therefore, the current standards of the MBMS service of the 3GPP communication protocol cannot satisfy the demand of the aforementioned V2X service.

Besides, if the MBMS broadcast areas are only described in terms of cell(s), due to a difference between the target area of the V2X message and the MBMS broadcast area, the user equipment probably receives too many irrelevant messages to cause a busy state thereof. For example, FIG. 2 is a schematic diagram illustrating a situation that a plurality of vehicles having different target areas uses the same MBMS broadcast area to broadcast their V2X messages. Referring to FIG. 2, the vehicles B, C, D and E in FIG. 2 all use the same broadcast area to implement broadcast, such that the vehicle A may receive the V2X messages sent by these vehicles. However, since the vehicle A is only within the target broadcast area of the vehicle B, the vehicle A is unnecessary to receive the V2X messages sent by the vehicles C, D and E.

In order to accurately describe the target area, although more broadcast areas can be planned, the user equipment has to constantly switch between different broadcast areas and update the related USD. If the delivery of the USD is delayed, it probably causes loss of important V2X messages.

Therefore, how to provide a V2X service that is compatible to the current standards of the MBMS service of the 3GPP communication protocol and meanwhile improve the performance for V2X message transmission is an important issue for related technicians of the field.

### SUMMARY OF THE DISCLOSURE

The disclosure is directed to a service identification method and a network entity and a user equipment using the same. According to the method, by allocating the content of a broadcast service identifier to include both of a service identification information and an area identification information, a user equipment is assisted to quickly confrm a broadcast service identifier of a broadcast service to be an identifier whose corresponding broadcast service content needs to be monitored.

The disclosure provides a service identification method adapted to a network entity, and the method includes at least but not limited to: receiving a broadcast service identifier allocation request; allocating at least one broadcast service identifier of at least one broadcast service in response to receiving the broadcast service identification allocation request, where each of the at least one broadcast service identifier includes both of a service identification information and an area identification information, the service identification information is used to identify the at least one broadcast service, and the area identification information is used to identify a target area corresponding to at least one broadcast service content of the at least one broadcast service; and transmitting the at least one broadcast service identifier comprising the service identification information and the area identification information.

The disclosure provides a network entity including a transmitter, a receiver and a processing circuit. The transmitter is configured to transmit data. The receiver is configured to receive data. The processing circuit is coupled to the transmitter and the receiver and configured to: receive a broadcast service identifier allocation request through the receiver; allocate at least one broadcast service identifier in response to receiving the broadcast service identifier allocation request, where each of the at least one broadcast service identifier includes both of a service identification information and an area identification information, the service identification information is used to identify the at least one broadcast service, and the area identification information is used to identify a target area corresponding to at least one broadcast service content of the at least one broadcast service; and transmit the at least one broadcast service identifier including the service identification information and the area identification information through the transmitter.

The disclosure provides a service identification method adapted to a user equipment, and the method includes at least but not limited to: receiving a first broadcast service identifier of a broadcast service, where the first broadcast service identifier includes both of a service identification information and an area identification information, the service identification information is associated with a first service, and the area identification information is associated with a target area corresponding to the first service; determining whether the first service is a service of interest of the user equipment according to the service identification information in the first broadcast service identifier; determining whether the user equipment is located within the target area according to the area identification information in the first broadcast service identifier in response to the result of determining the first service to be the service of interest of the user equipment; and monitoring and obtaining a broadcast service content corresponding to the first broadcast service identifier in response to the result of determining the user equipment to be located within the target area.

The disclosure provides a user equipment including a transmitter, a receiver and a processing circuit. The transmitter is configured to transmit wireless data. The receiver is configured to receive wireless data. The processing circuit is coupled to the transmitter and the receiver and configured to: receive a first broadcast service identifier of a broadcast service through the transmitter, where the first broadcast service identifier includes both of a service identification information and an area identification information, the service identification information is associated with a first service, and the area identification information is associated with a target area corresponding to the first service; determine whether the first service is a service of interest of the user equipment according to the service identification information in the first broadcast service identifier; determine whether the user equipment is located within the target area according to the area identification information in the first broadcast service identifier in response to the result of determining the first service to be the service of interest of the user equipment; and monitor and obtain a broadcast service content corresponding to the first broadcast service identifier in response to the result of determining the user equipment to be located within the target area.

According to the above description, in the service identification method and the network entity and the user equipment using the same provided by the disclosure, by allocating the content of the broadcast service identifier to include both of the service identification information and the area identification information, the user equipment (UE) is assisted to quickly confirm whether the broadcast service corresponding to the broadcast service identifier is negligible or non-negligible, by which the delay of message reception is reduced. Besides, regarding a plurality of the target areas probably overlapped to each other and belonging to a same service, though the broadcast service identifiers have the same service identification information, the area identification information can be used to differentiate different target areas, such that the broadcast service identifiers can be used to provide the V2X service and still being compatible to the current standards of the MBMS service of the 3GPP communication protocol.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification.

The drawings illustrate embodiments of the disclosure and, together with the description, serve to explain the principles of the disclosure.

FIG. 1 is a schematic diagram illustrating a situation that V2X information is broadcasted in different multimedia broadcast multicast services (MBMS) broadcast areas according to current locations of vehicle.

FIG. 2 is a schematic diagram illustrating a situation that a plurality of vehicles having different target areas uses the same MBMS broadcast area to broadcast their V2X messages.

FIG. 3 illustrates a TMGI format described by 3GPP TS 23.003.

FIG. 4 illustrates a MBMS service identifier according to an exemplary embodiment of the disclosure.

FIG. 5 is a flowchart illustrating a service identification method provided in the point of view of a network entity according to an exemplary embodiment of the disclosure.

FIG. 6 is a MBMS service identifier according to another exemplary embodiment of the disclosure.

FIG. 7 is a flowchart illustrating a service identification method provided in the point of view of a UE according to an exemplary embodiment of the disclosure.

FIG. 8 is a MBMS service identifier according to another exemplary embodiment of the disclosure.

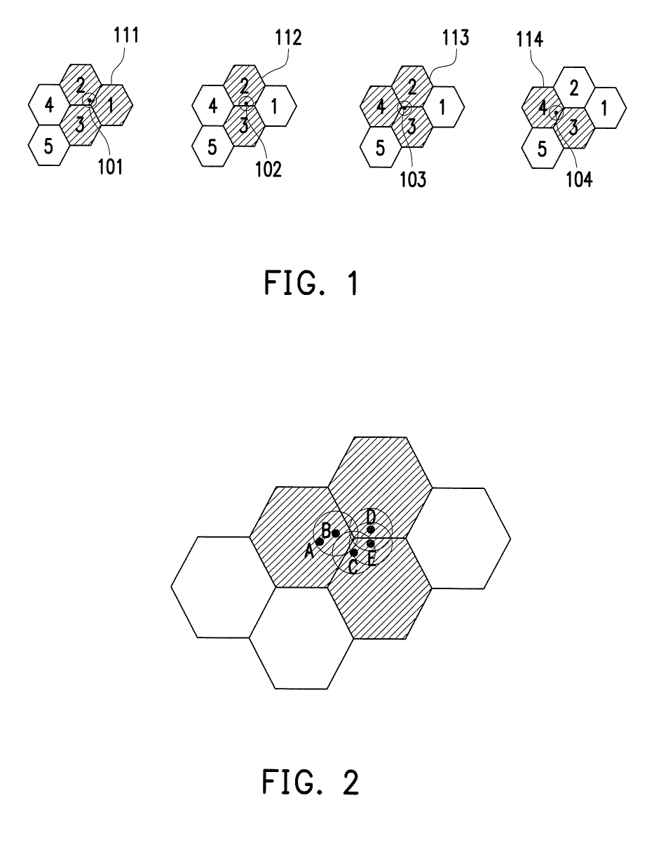

### DESCRIPTION OF EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

In the disclosure, key words or phrases related to 3GPP (for example, multimedia broadcast multicast services (MBMS), temporary mobile group identity (TMGI)) are only used for presenting the concepts of the disclosure, though the same concepts presented in the disclosure can also be used to any other system by those with ordinary skills in the art, for example, IEEE 802.11, IEEE 802.16, WiMAX and similarities. Therefore, the TMGI of the disclosure can be expanded to broadcast service identifiers of the other types used by networks of the other types, and the MBMS service of the disclosure can be expanded to broadcast services of the other types.

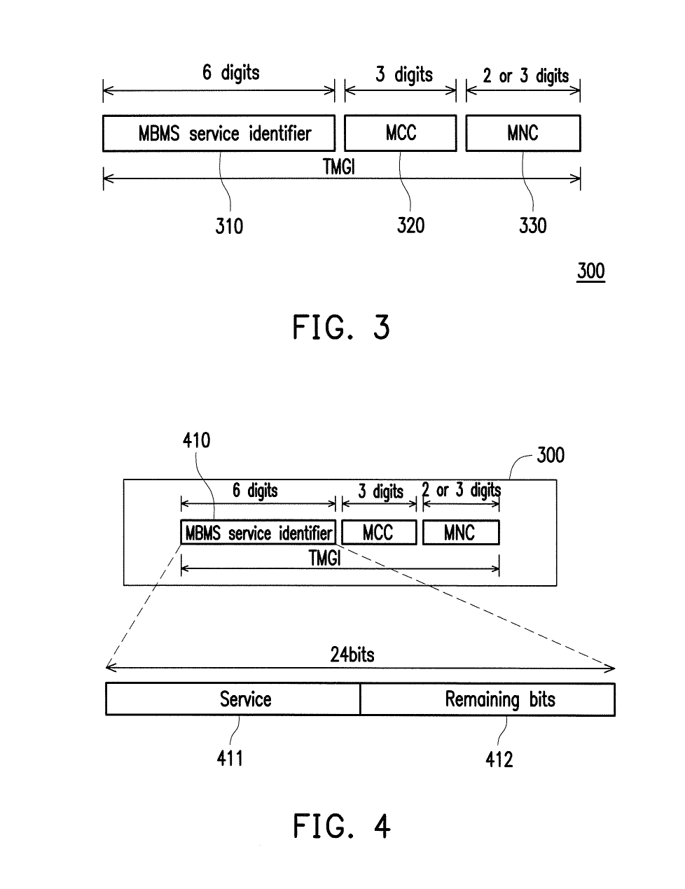

According to the current 3GPP standard TS 23.003, a chapter 15.2 specifies the TMGI for uniquely identifying multicast and broadcast bearer services in the MBMS. As shown in FIG. 3, FIG. 3 illustrates a format of the TMGI described by the 3GPP TS 23.003. Referring to FIG. 3, the format of the TMGI 300 is composed of three parts, which are respectively a MBMS service identifier 310, a mobile country code (MCC) 320 and a mobile network code (MNC) 330, etc. The MBMS service identifier 310 uniquely indicates a MBMS bearer service within a public land mobile network (PLMN). The MCC 320 is generally combined with the MNC 330 to uniquely identify a mobile network operator of a mobile device.

In the embodiment of the disclosure, in order to provide a V2X service compatible to the current standards of the MBMS service of the 3GPP communication protocol, and meanwhile improve the performance for V2X message delivery, the

MBMS service identifier 310 in the TMGI 300 is defined to achieve the above effects.

FIG. 4 illustrates a MBMS service identifier 410 according to an exemplary embodiment of the disclosure. Referring to FIG. 4, the MBMS service identifier 410 includes sections 411 and 412. It is assumed that front several bits (i.e. the section 411 ) of the MBMS service identifier 410 carry of the information to identify the MBMS service, and the remaining bits (i.e. the section 412) of the MBMS service identifier 410 can be used for carrying other information. Therefore, regarding the V2X information requiring to use overlapped broadcast areas to implement a MBMS broadcast service, the disclosure defines a TMGI with a specific format, and a user equipment (UE) may determine whether to monitor and obtain the broadcast service content corresponding to the TMGI according to the TMGI defined by the disclosure.

To be specific, in the disclosure, the TMGIs belonging to the same service may have the same service identification information, and a rest part of the TMGIs can be bits associated with geographic area information or other information or random bits, so as to differentiate different target broadcast areas or carry other information. In this way, although the TMGIs have the same service identification information, the rest part of the TMGIs may still make each of the TMGIs to be global unique.

In the following embodiment, a service identification method implemented based on the TMGI format of FIG. 4 is described in detail in view of a network entity and the UE.

It should be noted that the network entity of the disclosure can be a broadcast multicast service center (BMSC), though the disclosure is not limited thereto. For example, the network entity can be any one of a MBMS gateway (MBMS GW) and a mobility management entity (MME) in a core network, and a multi-cell/multicast coordination entity (MCE) in a radio access network.

In view of hardware, the network entity may at least include (but not limited to) a transmitter circuit, a receiver circuit, an analog-to-digital (A/D) converter, a digital-to-analog (D/A) converter, a processing circuit and an optional storage medium.

The transmitter circuit and the receiver circuit are used for transmitting and receiving a modulated signal, and the signal can be a RF signal (transmitted through one or a plurality of antennas), an optical signal or a signal transmitted through a cable. The transmitter circuit and the receiver circuit may also execute operations of low noise amplification, impedance matching, frequency mixing, frequency up or down conversion, filtering, amplifying or other similar operations. The A/D converter is configured to convert a signal from an analog signal into a digital signal, and the D/A converter is configured to convert the signal from the digital signal into the analog signal.

The processing circuit is configured to process digital signals and execute functions, processing programs or steps of the method provided by the exemplary embodiment of the disclosure. Moreover, the processing circuit can be selectively coupled to a memory circuit to store a program code, a device configuration, a codebook, buffered or permanent data, etc. The functions of the processing circuit can be implemented by a programmable unit such as a microprocessor, a micro controller, a DSP chip, a programmable unit, etc. The functions of the processing circuit can also be implemented by an independent electronic device or an integrated circuit (IC), and the processing circuit can be implemented by hardware or software.

Moreover, in the disclosure, the “user equipment (UE)” has various implementations, which, for example, includes (but not limited to) a mobile station, an advanced mobile station (AMS), a server, a client terminal, a desktop computer, a laptop computer, a network computer, a work station, a personal digital assistant (PDA), a tablet personal computer (PC), a scanner, a telephone device, a pager, a camera, a television, a handheld video game device, a music device, a wireless sensor and similarities. In some applications, the UE can be a fixed computer device operated in a mobile environment such as a bus, a train, an airplane, a boot, a vehicle, etc.

In view of hardware, the UE may include at least (but not limited to) a transmitter circuit, a receiver circuit, an A/D converter, a D/A converter, a processing circuit, one or a plurality of antenna units and an optional memory circuit. The memory circuit may store a program code, a device configuration, buffered or permanent data, a codebook, etc. The processing circuit can also be implemented by hardware or software, and is regarded as functions, processing programs or programs and method steps used for implementing the embodiment of the disclosure. Function of each component of the UE is similar to the network entity, so that detailed description of each component is not repeated.

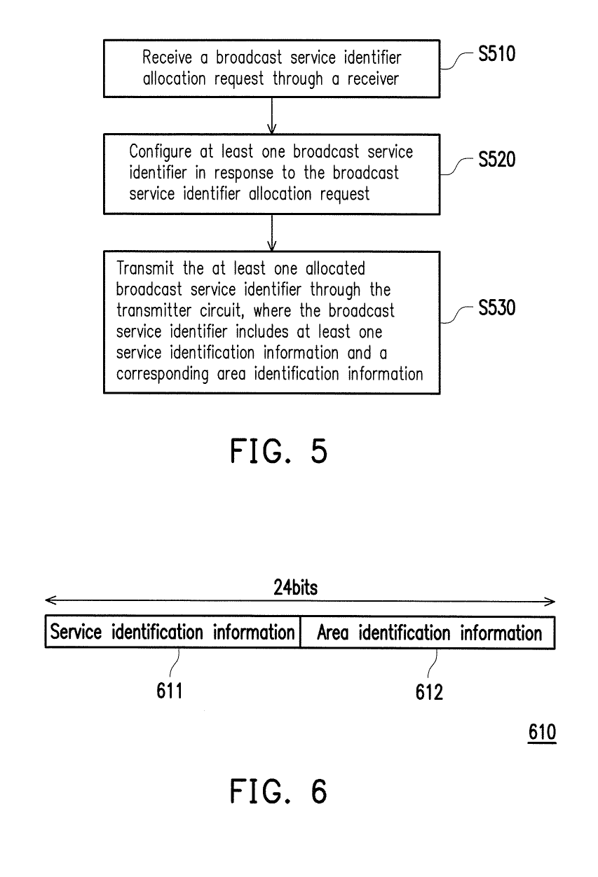

Referring to FIG. 5, FIG. 5 is a flowchart illustrating a service identification method provided in the point of view of a network entity according to an exemplary embodiment of the disclosure.

In step S510, the network entity receives a broadcast service identifier allocation request through a receiver. In the present embodiment, the network entity implemented by a BMSC is taken as an example for description, and the BMSC is configured in a core network and executes authentication/authorization of a content provider, and allocates broadcast service identifiers expected by the content provider. An application service server transmits the broadcast service identifier allocation request to the BMSC, and the BMSC may allocate the broadcast service identifier according to the broadcast service identifier allocation request.

In the present embodiment, the broadcast service identifier allocation request at least includes at least one service information and a corresponding target area information.

The broadcast service identifier allocated according to the request of the application service server can be implemented based on the TMGI format of FIG. 4. Therefore, the broadcast service identifier is compatible with the TMGI of the MBMS service in the 3GPP standards. The service information in the broadcast service identifier allocation request is provided to assist the network entity to configure a service identification information of the broadcast service identifier, and the service identification information is used to identify the MBMS service. The MBMS service broadly refers to the V2V, V2I, V2P or V 2 N service in the V2X vehicle data transmission technique, or a specific service such as a cooperative crossroad collision avoidance system, front collision warning and a curve speed warning, etc.

In step S520, the network entity configures at least one broadcast service identifier in response to the broadcast service identifier allocation request. In the present embodiment, besides the service identification information used for identifying the MBMS service, the network entity further configures an area identification information according to a geographic area information based on the TMGI format defined in FIG. 4, so as to allocate the broadcast service identifier. Therefore, FIG. 6 is a MBMS service identifier 610 according to another exemplary embodiment of the disclosure, which is a schematic diagram of further defining the sections 411 and 412 in the MBMS service identifier 410 based on the TMGI format defined in FIG. 4, such that the section 412 carries the area identification information associated with a target area. The area identification information is used to identify the target area corresponding to the broadcast service content broadcasted based on the MBMS service.

Referring to FIG. 6, the MBMS service identifier 610 includes a section 611 carrying the service identification information and a section 612 carrying the area identification information. The section 611 is the same to the section 411 of FIG. 4, and the service identification information carried by the section 611 is a bit string indicating the MBMS service, which may have a fixed length or a variable length. The service identification information carried by the section 611 can be configured according to the service information in the broadcast service identifier allocation request.

The area identification information carried by the section 612 is a bit string indicating geographic area information, which can be configured according to the target area information in the broadcast service identifier allocation request. It should be noted that the target area can be at least one predetermined area, at least one road segment or at least one road intersection or an area corresponding to at least one MBMS service area identity (SAI) or at least one cell ID.

In the present embodiment, it is assumed that the target area is a predetermined area which can be of a specific boundary. The area identification information carried by the section 612 may include an area type and an area description parameter, etc., associated with the target area, though implementation of the geographic area information of the disclosure is not limited thereto. It should be noted that the area type and the corresponding area description parameter included in the area identification information carried by the section 612 can be changed according to a user setting. For example, the area type is, for example, an area shape (for example, a round shape or a square shape) of the target area, and the area description parameter may define a size and a location of the target area. To be specific, if the area type is mapped to an area shape, the UE may use the area description parameter to obtain a coverage range of the target area. Therefore, a judging function corresponding to the area type can be used by the UE to determine, when it receives the broadcast service identifier, whether it is located in the target area according to the area description parameter.

In another embodiment, it is assumed that the target area is a road segment or a road intersection, and the area identification information carried by the section 612 may include a road segment identifier or a road intersection identifier associated with the target area. In this way, the UE may determine whether itself is located in the target area according to a current location of itself, i.e. whether the UE is located on a road segment or near a road intersection represented by the road segment identifier or the road intersection identifier. In another embodiment, it is assumed that the target area is an area corresponding to the MBMS SAIs or the cell IDs, and the area identification information carried by the section 612 may include MBMS SAIs or the cell IDs associated with the target area. In this case, the UE may determine whether itself is located in the target area according to the MBMS SAIs or the cell IDs that it currently stay, i.e. determine whether itself is located in the area represented by the MBMS SAIs or the cell IDs in the area identification information.

In other words, based on the TMGI format of FIG. 4 and FIG. 6, the network entity may configure each of the broadcast service identifiers to include both of the service identification information (i.e. the bit string carried by the section 611 ) and the area identification information (i.e. the bit string carried by the section 612 ) in response to the broadcast service identifier allocation request, so as to assist the UE to confirm the related MBMS broadcast service.

In the embodiment of the disclosure, regarding the broadcast service identifiers with the same service but different target areas, the network entity may configure the service identification information corresponding to the service according to the service information of the same service, such that the at least one broadcast service identifiers corresponding to the same service may have the same service identification information. Moreover, the network entity may further configure different area identification information corresponding to different target areas for the at least one broadcast service identifier with the same service, so that the at least one broadcast service identifier with the same service but corresponding to the different broadcast service contents can be differentiated. It should be noted that since the at least one broadcast service identifier is configured with the area identification information corresponding to each area in different target areas, each area in the different target areas can be overlapped with each other. In this way, not only the broadcast service identifier is unnecessary to be distinguished by using a flow identifier, it can also be transmitted in the overlapped areas.

Then, after the network entity completes allocating the broadcast service identifier, in step S530, the network entity may transmit the at least one allocated broadcast service identifier through the transmitter circuit, where the broadcast service identifier includes at least one service identification information and a corresponding area identification information. The network entity may transmit back the configured broadcast service identifiers to the application server, and may also transmit the configured broadcast service identifiers to one or a plurality of base stations, where the one or a plurality of base stations transmits the broadcast service identifiers to the UE.

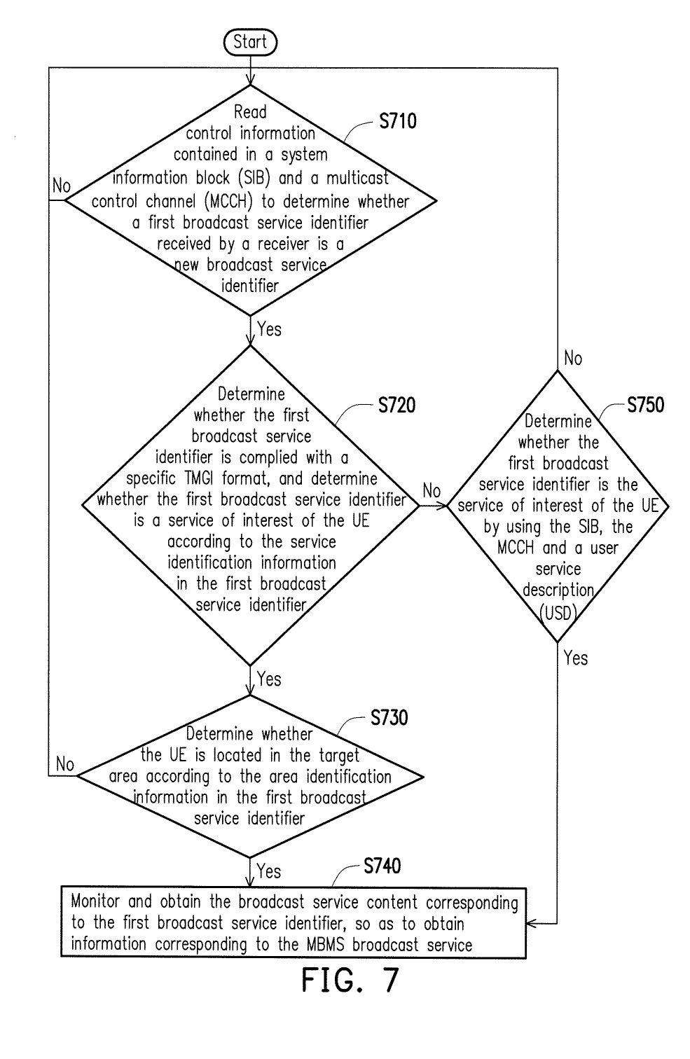

FIG. 7 is a flowchart illustrating a service identification method provided in the point of view of a UE according to an exemplary embodiment of the disclosure.

In step S710, the UE reads control information contained in a system information block (SIB) and a multicast control channel (MCCH) to determine whether a first broadcast service identifier received by a receiver is a new broadcast service identifier. In the present embodiment, the first broadcast service identifier can be complied with the TMGI format defined by the disclosure or is not complied with the TMGI format defined by the disclosure. When the first broadcast service identifier is complied with the TMGI format defined by the disclosure, the first broadcast service identifier includes both of the service identification information and the area identification information, where the service identification information is associated with a first service, and the area identification information is associated with the target area corresponding to the first service.

If the UE does not receive a new broadcast service identifier, the UE again executes the step S710 to keep updating the information on the SIB and the MCCH, and keep determining whether a new broadcast service identifier is received.

Conversely, if the UE receives the first broadcast service identifier which is a new broadcast service identifier, the UE executes a step S720 to analyze the first broadcast service identifier. In the step S720, the UE determines whether the first broadcast service identifier is complied with a specific TMGI format, and determines whether the first broadcast service identifier is a service of interest of the UE according to the service identification information in the first broadcast service identifier.

In the present embodiment, the UE has a pre-configured list of identifiers of interest. The list of identifiers of interest includes a plurality of second broadcast service identifiers. It should be noted that a format of the second broadcast service identifiers can be the TMGI format described according to the current 3GPP standard TS 23.003 (referring to the TMGI format shown in FIG. 3), though the disclosure is not limited thereto, and the spirit of the disclosure is met as long as the second broadcast service identifier includes information associated with the service thereof. In this case, the UE may determine whether the first service is complied with any one of second services in the second broadcast service identifiers according to the service identification information in the first broadcast service identifier, so as to determine whether the first service is the service of interest of the UE. If yes, a step S730 is executed.

In the step S730, in response to the result of determining the first service to be the service of interest of the UE, the UE determines whether the UE is located in the target area according to the area identification information in the first broadcast service identifier.

In the present embodiment, if the target area is a predetermined area, the area identification information includes the area type associated with the target area and the area description parameter associated with the area type. The area type is mapped to a judging function, and the judging function is used for determining whether the UE is located in the target area according to the area description parameter. The UE is required to obtain a current location of itself, and determine whether the current location of the UE is located in the target area according to the area type and the corresponding judging function.

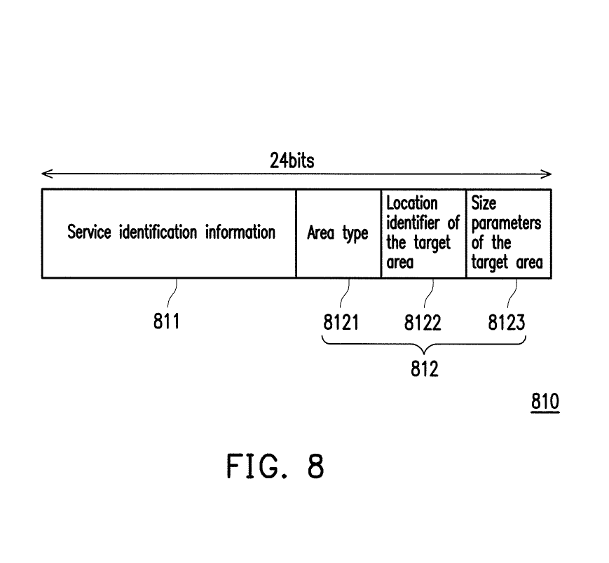

For example, referring to FIG. 8, FIG. 8 is a MBMS service identifier 810 according to another exemplary embodiment of the disclosure, which is a schematic diagram of further defining the section 612 in the MBMS service identifier 610 based on the TMGI format defined in FIG. 6. In the present embodiment, the section 811 also carries the service identification information, and the section 812 also carries the area identification information. It should be noted that the area identification information received by the UE includes an area type 8121, and a location identifier 8122 of the target area and a size parameter 8123 of the target area used for representing the area description parameter.

The area type 8121 is an area shape of the target area. In an embodiment, when the area type 8121 is a round shape, the UE may obtain a judging function corresponding to the round shape according to the area type 8121, and substitute the location identifier 8122 of the target area and the size parameter 8123 of the target area of the area description parameter into the judging function. In this case, the judging function used for determining whether the current location of the UE is located in the target area can be represented as:

\sqrt{(x−xₚ)²+(y−yₚ)²}≦a×s equation (1)

In the equation (1), (x,y) represents the current location of the UE, (xₚ, yₚ) represents a center location of the target area, and (xₚ, yₚ) is obtained based on the location identifier 8122 of the target area, a represents a radius of the round shape, which can be obtained according to the size parameter 8123 of the target area, and s represents a scaling factor. When the current location of the UE satisfies the judging function of the equation (1), it is determined that the UE is located in the target area, and vice-versa.

In another embodiment, when the area type 8121 is a square, the UE may obtain a judging function corresponding to the square according to the area type 8121, and substitute the location identifier 8122 of the target area and the size parameter 8123 of the target area of the area description parameter into the judging function. In this case, the judging function used for determining whether the current location of the UE is located in the target area can be represented as:

$$( {x}_{p} - \frac{a \times s}{2} \leq x \leq {x}_{p} + \frac{a \times s}{2} ) \&\& ( {y}_{p} - \frac{a \times s}{2} \leq y \leq {y}_{p} + \frac{a \times s}{2} ) \qquad equation ( 2 )$$

In the equation (2), (x,y) represents the current location of the UE, (xₚ, yₚ) represents a center location of the target area, and (xₚ, yₚ) is obtained based on the location identifier 8122 of the target area, a represents a edge length of the square, which can be obtained according to the size parameter 8123 of the target area, and s represents a scaling factor. When the current location of the UE satisfies the judging function of the equation (2), it is determined that the UE is located in the target area, and vice-versa.

In other embodiments, when the target area is a road segment or a road intersection, the area identification information received by the UE includes a road segment identifier or a road intersection identifier associated with the target area. Therefore, the UE may obtain the road information of the current location, and determine whether the road information matches the road segment identifier or the road intersection identifier. If the target area is an area corresponding to the MBMS SAIs or the cell IDs, the area identification information received by the UE can be MBMS SAIs or the cell IDs, or an output value of other function (for example, a hash function) used for processing the MBMS SAIs or the cell IDs, the UE may determine whether it is located in the target area according to the MBMS SAIs or the cell IDs corresponding to the current location of UE.

Then, if the UE is not located in the target area, it represents that the UE may neglect the broadcast service corresponding to the first broadcast service identifier, and the UE returns to the step S710 to keep updating the received SIB and the MCCH, and keep determining whether a new first broadcast service identifier is received.

Conversely, if the UE is located in the target area, a step S740 is executed, by which the UE keeps monitoring and obtaining the broadcast service content corresponding to the first broadcast service identifier, so as to obtain information corresponding to the MBMS broadcast service.

Referring back to the step S720, if the UE determines that the first broadcast service identifier is not complied with the specific TMGI format, or determines that the first service is not the service of interest of the UE, the UE executes a step S750.

In the step S750, the UE determines whether the first broadcast service identifier is the service of interest of the UE by using the SIB, the MCCH and a user service description (USD). In the present embodiment, since the USD is used for transmitting information (for example, a source Internet protocol (IP) address, a destination IP address, a port and TMGI, etc.) related to a broadcast multicast service to the UE receiving the MBMS service, the UE may determine whether the first broadcast service identifier is the service of interest of the UE through the USD.

In the step S750, if it is determined that the first broadcast service identifier is not the service of interest of the UE, the UE returns to the step S710 to keep updating the received SIB and the MCCH, and keep determining whether a new first broadcast service identifier is received.

Conversely, in the step S750, if it is determined that the service identification information in the first broadcast service identifier is the service of interest of the UE, the UE executes the step S740 to monitor and obtain the broadcast service content corresponding to the first broadcast service identifier.

In summary, in the service identification method and the network entity and the user equipment using the same provided by the disclosure, the network entity allocates the content of the broadcast service identifier to include both of the service identification information and the area identification information, the UE is assisted to quickly confirm whether the broadcast service corresponding to the broadcast service identifier is negligible or non-negligible, by which the delay of message reception is reduced. Besides, regarding a plurality of the target areas probably overlapped to each other and belonging to a same service, though the broadcast service identifiers have the same service identification information, the area identification information can be used to differentiate different target areas, such that the broadcast service identifiers can be used to provide the V2X service and still being compatible to the current standards of the MBMS service of the 3GPP communication protocol.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A service identification method, adapted to a network entity, and the method comprising:
receiving a broadcast service identifier allocation request;
allocating at least one broadcast service identifier of at least one broadcast service in response to receiving the broadcast service identifier allocation request, wherein each of the at least one broadcast service identifier comprises both of a service identification information and an area identification info nation, the service identification information is used to identify the at least one broadcast service, and the area identification information is used to identify a target area corresponding to at least one broadcast service content of the at least one broadcast service; and
transmitting the at least one broadcast service identifier comprising the service identification information and the area identification information.

2. The service identification method as claimed in claim 1, wherein an application service server providing the broadcast service transmits the broadcast service identifier allocation request, and the broadcast service identifier allocation request at least comprises a service information of the at least one broadcast service and a target area information corresponding to the at least one broadcast service content.

3. The service identification method as claimed in claim 1, wherein the number of the at least one broadcast service identifier is greater than 1, and the step of allocating the at least one broadcast service identifier comprises:
configuring the service identification information corresponding to the broadcast service to the broadcast service identifiers with the same broadcast service; and
respectively configuring the area identification information corresponding to different target areas to the broadcast service identifiers with the same broadcast service.

4. The service identification method as claimed in claim 3, wherein the different target areas are overlapped to each other.

5. The service identification method as claimed in claim 1, wherein the target area comprises a predetermined area, the area identification information comprises an area type and an area description parameter associated with the target area, the area type is mapped to a determination function, and the determination function is configured to determine whether a user equipment receiving the broadcast service identifier is located within the predetermined area according to the area description parameter.

6. The service identification method as claimed in claim 1, wherein the target area comprises a road segment or a road intersection, and the area identification information comprises a road segment identifier or a road intersection identifier associated with the target area.

7. The service identification method as claimed in claim 1, wherein the target area comprises an area corresponding to a multimedia broadcast multicast services service area identity (MBMS SAI) or a cell ID, and the area identification information comprises the MBMS SAI or the cell ID associated with the target area.

8. The service identification method as claimed in claim 1, wherein each of the at least one broadcast service identifier is global unique.

9. The service identification method as claimed in claim 1, wherein the broadcast service identifier is compatible to a temporary mobile group identity (TMGI) of a MBMS service in 3GPP standards.

10. A network entity, comprising:
a transmitter, configured to transmit data;
a receiver, configured to receive data; and
a processing circuit, coupled to the transmitter and the receiver and configured to:
receive a broadcast service identifier allocation request through the receiver;
allocate at least one broadcast service identifier in response to receiving the received broadcast service identifier allocation request, wherein each of the at least one broadcast service identifier comprises both of a service identification information and an area identification information, the service identification information is used to identify the at least one broadcast service, and the area identification information is used to identify a target area corresponding to at least one broadcast service content of the at least one broadcast service; and
transmit the at least one broadcast service identifier comprising the service identification information and the area identification information through the transmitter.

11. The network entity as claimed in claim 10, wherein an application service server providing the broadcast service transmits the broadcast service identifier allocation request, and the broadcast service identifier allocation request at least comprises a service information of the at least one broadcast service and a target area information corresponding to the at least one broadcast service content.

12. The network entity as claimed in claim 10, wherein the number of the at least one broadcast service identifier is greater than 1, and the processing circuit is further configured to:
configure the service identification information corresponding to the broadcast service to the broadcast service identifiers with the same broadcast service; and
respectively configure the area identification information corresponding to different target areas to the broadcast service identifiers with the same broadcast service.

13. The network entity as claimed in claim 12, wherein the different target areas are overlapped to each other.

14. The network entity as claimed in claim 10, wherein the target area comprises a predetermined area, the area identification information comprises an area type and an area description parameter associated with the target area, the area type is mapped to a determination function, and the determination function is configured to determine whether a user equipment receiving the broadcast service identifier is located within the predetermined area according to the area description parameter.

15. The network entity as claimed in claim 10, wherein the target area comprises a road segment or a road intersection, and the area identification information comprises a road segment identifier or a road intersection identifier associated with the target area.

16. The network entity as claimed in claim 10, wherein the target area comprises an area corresponding to a multimedia broadcast multicast services service area identity (MBMS SAI) or a cell ID, and the area identification information comprises the MBMS SAI or the cell ID associated with the target area.

17. The network entity as claimed in claim 10, wherein each of the at least one broadcast service identifier is global unique.

18. The network entity as claimed in claim 10, wherein the broadcast service identifier is a temporary mobile group identity (TMGI) of a MBMS service in 3GPP standards.

19. A service identification method, adapted to a user equipment, and the method comprising:
receiving a first broadcast service identifier of a broadcast service, wherein the first broadcast service identifier comprises both of a service identification information and an area identification information, the service identification information is associated with a first service, and the area identification information is associated with a target area corresponding to the first service;
determining whether the first service is a service of interest of the user equipment according to the service identification information in the first broadcast service identifier;
determining whether the user equipment is located within the target area according to the area identification information in the first broadcast service identifier in response to the result of determining the first service to be the service of interest of the user equipment; and
monitoring and obtaining a broadcast service content corresponding to the first broadcast service identifier in response to the result of determining the user equipment to be located within the target area.

20. The service identification method as claimed in claim 19, wherein the user equipment has a pre-configured list of identifiers of interest, the list of identifiers of interest comprises a plurality of second broadcast service identifiers, wherein the step of determining whether the first service is a service of interest of the user equipment according to the service identification information in the first broadcast service identifier comprises:
determining whether the first service is complied with any one of a plurality of second services in the plurality of second broadcast service identifiers; and
determining the first service to be the service of interest in response to the result of determining the first service to be complied with any one of the second services in the second broadcast service identifiers, and otherwise, determining the first service not to be the service of interest.

21. The service identification method as claimed in claim 19, wherein the target area comprises a predetermined area, the area identification information comprises an area type associated with the target area and an area description parameter associated with the area type, the area type is mapped to a determination function, and the determination function is configured to determine whether the user equipment is located within the predetermined area according to the area description parameter.

22. The service identification method as claimed in claim 21, wherein the step of determining whether the user equipment is located within the target area according to the area identification information in the first broadcast service identifier comprises:
obtaining a current location of the user equipment; and
substituting the area description parameter into the determination function, and determining whether the current location of the user equipment is located within the predetermined area according to the determination function.

23. The service identification method as claimed in claim 19, wherein the target area comprises a road segment or a road intersection, and the area identification information comprises a road segment identifier or a road intersection identifier associated with the target area.

24. The service identification method as claimed in claim 21, wherein the step of determining whether the user equipment is located within the target area according to the area identification information in the first broadcast service identifier comprises:
obtaining a road information of a current location of the user equipment; and
determining whether the road information is complied with the road segment identifier or the road intersection identifier.

25. The service identification method as claimed in claim 19, wherein the target area comprises an area corresponding to a multimedia broadcast multicast services service area identity (MBMS SAI) or a cell ID, and the area identification information comprises the MBMS SAI or the cell ID associated with the target area.

26. The service identification method as claimed in claim 19, wherein in response to the result of determining the user equipment to be not within the target area, the service identification method further comprises:
keeping updating a received system information block (SIB) and a multicast control channel (MCCH) to determine whether a new first broadcast service identifier is received.

27. The service identification method as claimed in claim 19, wherein in response to the result of determining the first service to be not the service of interest of the user equipment, the method further comprises:
using the SIB, the MCCH and a USD to determine whether the first broadcast service identifier is the service of interest of the user equipment; and
keeping monitoring and obtaining the broadcast service content corresponding to the first broadcast service identifier to obtain the broadcast service content of the broadcast service in response to the result of determining the first broadcast service identifier to be the service of interest of the user equipment.

28. The service identification method as claimed in claim 19, wherein the first broadcast service identifier is compatible to a temporary mobile group identity (TMGI) of a MBMS service in 3GPP standards.

29. A user equipment, comprising:
a transmitter, configured to transmit wireless data;
a receiver, configured to receive the wireless data; and
a processing circuit, coupled to the transmitter and the receiver, and configured to:
receive a first broadcast service identifier of a broadcast service through the transmitter, wherein the first broadcast service identifier comprises both of a service identification information and an area identification information, the service identification information is associated with a first service, and the area identification information is associated with a target area corresponding to the first service;
determine whether the first service is a service of interest of the user equipment according to the service identification information in the first broadcast service identifier;
determine whether the user equipment is located within the target area according to the area identification information in the first broadcast service identifier in response to the result of determining the first service to be the service of interest of the user equipment; and
monitor and obtain a broadcast service content corresponding to the first broadcast service identifier in response to the result of determining the user equipment to be located within the target area.

30. The user equipment as claimed in claim 29, wherein the user equipment has a pre-configured list of identifiers of interest, the list of identifiers of interest comprises a plurality of second broadcast service identifiers, wherein the processing circuit is further configured to:
determine whether the first service is complied with any one of a plurality of second services in the plurality of second broadcast service identifiers; and
determine the first service to be the service of interest in response to the result of determining the first service to be complied with any one of the second services, and otherwise, determine the first service not to be the service of interest.

31. The user equipment as claimed in claim 29, wherein the target area comprises a predetermined area, the area identification information comprises an area type associated with the target area and an area description parameter associated with the area type, the area type is mapped to a determination function, and the determination function is configured to determine whether the user equipment is located within the predetermined area according to the area description parameter.

32. The user equipment as claimed in claim 31, wherein the processing circuit is further configured to:
obtain a current location of the user equipment; and
substitute the area description parameter into the determination function, and determine whether the current location of the user equipment is located within the predetermined area according to the determination function.

33. The user equipment as claimed in claim 29, wherein the target area comprises a road segment or a road intersection, and the area identification information comprises a road segment identifier or a road intersection identifier associated with the target area.

34. The user equipment as claimed in claim 33, wherein the processing circuit is further configured to:
obtain a road information of a current location of the user equipment; and
determine whether the road information is complied with the road segment identifier or the road intersection identifier.

35. The user equipment as claimed in claim 29, wherein the target area comprises an area corresponding to a multimedia broadcast multicast services service area identity (MBMS SAI) or a cell ID, and the area identification information comprises the MBMS SAI or the cell ID associated with the target area.

36. The user equipment as claimed in claim 29, wherein in response to the result of determining the user equipment to be not within the target area, the processing circuit is further configured to:
keep updating a received system information block (SIB) and a multicast control channel (MCCH) to determine whether a new first broadcast service identifier is received.

37. The user equipment as claimed in claim 29, wherein in response to the result of determining the first service to be not the service of interest of the user equipment, the processing circuit is further configured to:
use the SIB, the MCCH and a USD to determine whether the first broadcast service identifier is the service of interest of the user equipment; and
keep monitoring and obtaining the broadcast service content corresponding to the first broadcast service identifier to obtain the broadcast service content of the broadcast service in response to the result of determining the first broadcast service identifier to be the service of interest of the user equipment.

38. The user equipment as claimed in claim 29, wherein the first broadcast service identifier is compatible to a temporary mobile group identity (TMGI) of a MBMS service in 3GPP standards.
